(19) United States
(12) Patent Application Publication
(10) Pub. No.: US 2025/0304470 A1
(43) Pub. Date: Oct. 2, 2025

(54) Sand-manure liquid separation plant including a pre-separator including a cyclone, a cyclone and use of the cyclone in a sand-manure liquid separation plant and a method of operating the plant

(71) Applicant: Stjernholm A/S, Randers SV (DK)

(72) Inventors: Kaj Nees Sørensen STJERNHOLM, Randers SV (DK); Thomas Fleischer CHRISTIANSEN, Randers SV (DK); Bent Ejnar Juul SIMONSEN, Randers SV (DK)

(73) Assignee: Stjernholm A/S, Randers SV (DK)

(21) Appl. No.: 18/944,796

(22) Filed: Nov. 12, 2024

(30) Foreign Application Priority Data
Apr. 2, 2024 (EP) 24168009.9

(51) Int. Cl. C02F 1/38; B04C 5/04; B04C 5/14; B04C 11/00; C02F 1/00; C02F 103/20

(52) U.S. Cl. CPC C02F 1/385; B04C 5/04; B04C 5/14; B04C 11/00; C02F 1/008; C02F 2001/007; C02F 2103/20; C02F 2209/40

(57) ABSTRACT

A sand-manure liquid separation plant including a tank for processing a mixture of sand and manure liquid; the tank including, a top portion including a mixture inlet for introducing the mixture into the tank, a bottom portion including a sand discharge. A pre-separator for a raw stream of sand mixed with manure liquid, the pre-separator including a cyclone, an outlet portion of the cyclone at a bottom part of the cyclone being arranged at the top portion of the tank for the mixture leaving the cyclone to be processed in the tank to flow into the tank by gravity via the mixture inlet. The outlet portion of the cyclone including a flow restriction portion having a through-going passage. A clamping body engaging an outer periphery of the flow restriction portion, the first clamping body being adjustable to vary the cross-section of the through-going passage of the flow restriction portion.

This application claims priority under 35 U.S.C. § 119(a) to European Patent Application No. 24168009.9, filed on Apr. 2, 2024, the entire contents of which are incorporated herein by reference.

### BACKGROUND OF THE INVENTION

### Field of the Invention

The invention concern a sand-manure liquid separation plant including a tank for processing a mixture of sand and manure liquid; the tank including, a top portion including a mixture inlet for introducing the mixture to be processed into the tank, a bottom portion including a sand discharge, wherein the plant further includes a pre-separator for a raw stream of sand mixed with manure liquid, the pre-separator including a cyclone, a tubular outlet portion of the cyclone at a bottom part of the cyclone being arranged at the top portion of the tank for the mixture leaving the cyclone to be processed in the tank to flow into the tank by gravity via the mixture inlet, the outlet portion of the cyclone including a flow restriction portion being of a resilient material and having a through-going passage for the mixture, the plant including a control unit to control an output flow from the cyclone of the mixture to be introduced into the tank via the through-going passage, a first clamping body engaging an outer periphery of the flow restriction portion, the first clamping body being adjustable to vary the cross-section of the through-going passage of the flow restriction portion, the first clamping body optionally being removable from the outlet portion and replaceable. The invention also concerns a cyclone including a tubular outlet portion, where the outlet portion including a flow restriction portion being of a resilient material having a through-going passage, a first clamping body engaging an outer periphery of the flow restriction portion, the first clamping body being adjustable to vary the cross section of the through-going passage of the flow restriction portion, the first clamping body optionally being removable from the outlet portion and replaceable and use of the cyclone in a sand-manure liquid separation plant and a method of operating the plant.

### Background Art

When handling manure in stables or barns, where sand is used as bedding material, the presence of sand in the manure running through a manure handling plant may cause severe wear on parts of the plant in contact with the sand. Sand beddings are often preferred to organic material bedding materials due to the lower rate of bacterial growth.

A sand-manure liquid separation plant generally may operate to clean and concentrate the sand so that it can be reused in the stables or barns. Reusing as much of the sand as possible as a bedding material saves money for the farmer, and the benefits are enhanced where the separated sand fulfils certain quality requirements. In certain cases the farmer may wish to use very fine sand for the bedding in order to increase animal welfare since such a bedding is more comfortable to lie on for the animal and reduces the formation of wounds.

Therefore, an object of the invention is to provide for an optimization of a sand-manure liquid separation plant.

### DESCRIPTION OF THE INVENTION

When describing the below embodiments, the present invention envisages all possible combinations and permutations of the below embodiments with the disclosed aspects.

Disclosed herein in a first aspect is a sand-manure liquid separation plant including a tank for processing a mixture of sand and manure liquid; the tank including:
a top portion including a mixture inlet for introducing the mixture to be processed into the tank,
a bottom portion including a sand discharge,
   wherein
the plant further includes a pre-separator for a raw stream of sand mixed with manure liquid, the pre-separator including a cyclone, a tubular outlet portion of the cyclone at a bottom part of the cyclone being arranged at the top portion of the tank for the mixture leaving the cyclone to be processed in the tank to flow into the tank by gravity via the mixture inlet,
the outlet portion of the cyclone including a flow restriction portion being of a resilient material and having a through-going passage for the mixture,
the plant including a control unit to control an output flow from the cyclone of the mixture to be introduced into the tank via the through-going passage,
a first clamping body engaging an outer periphery of the flow restriction portion, the first clamping body being adjustable to vary the cross-section of the through-going passage of the flow restriction portion, the first clamping body optionally being removable from the outlet portion and replaceable.

Also disclosed herein in a second aspect is a cyclone including a tubular outlet portion, where the outlet portion including a flow restriction portion being of a resilient material having a through-going passage, a first clamping body engaging an outer periphery of the flow restriction portion, the first clamping body being adjustable to vary the cross-section of the through-going passage of the flow restriction portion, the first clamping body optionally being removable from the outlet portion and replaceable.

In one or more embodiments of the first or second aspect, the adjustment of the first clamping body follows an adjustment command thereby adjusting the output flow of the mixture into the tank. The adjustment comment may be send by the control unit to an actuator, thereby adjusting the output flow of the mixture into the tank.

In one or more embodiments of the first or second aspect, the actuator may be a rotating actuator or a linear actuator. In one or more embodiments of the first or second aspect, the actuator is a spindle. The spindle may be a rotating spindle.

The raw stream of sand mixed with manure liquid is also called the raw manure. Both the raw stream of sand mixed with manure liquid and the mixture of sand and manure liquid contains organic matters. The tank including the raw stream of sand mixed with manure liquid is also called the raw manure tank. Manure liquid is a mixture of animal waste and organic matter. It includes animal feces and urine and may contain wasted feed.

By being able to adjust the cross-section of the through-going passage of the flow restriction portion and thereby control the output flow from the cyclone of the mixture to be introduced into the tank via the through-going passage an optimization of the sand-manure liquid separation plant is assured.

The raw stream of sand mixed with manure liquid is pumped from a tank (raw manure tank) via a connecting pipe into the pre-separator. In one or more examples, the connecting pipe including a dry matter meter and a flow meter. The raw stream of sand mixed with manure liquid may be mixed with water (from a flush water tank) to reach a required/desired dry matter percentage.

A pre-separation of the raw stream of sand mixed with manure liquid is done in the cyclone. The sand material gravitates through the cyclone and into the tank via the mixture inlet. In the cyclone, the sand material is pre-separated from the manure liquid by the function of the cyclone and the difference in density between sand and liquid. The cyclone can control and sort the particles based on the particle mass. In one or more examples, the particle mass can be controlled down to 1 to 2 grams. The part of the liquid that is free of sand is forced out through the top of the cyclone, while the rest with the heavier sand flows out through the outlet portion of the cyclone at a bottom part of the cyclone.

The tank for processing the mixture of sand and manure liquid treats and washes the material, and the washed sand is transported from the bottom of the tank by means of one or more screw conveyor and is stored in a sand pile until use. Each sand-manure liquid separation plant can include between 1 to 4 screw conveyers, and each screw conveyer can process up to 1500 kg sand per hour e.g. in the interval between 800 to 1000 kg. In one or more examples, the washed sand contains less than 3% by weight of organic matters.

The majority of the manure liquid part of the raw stream of sand mixed with manure liquid and the majority of the organic matters of the raw stream of sand mixed with manure liquid will be rejected upwards by the cyclone and can be transported to a unit (drum screen) for mechanical separation of the material into thin material (having small particles sizes) and thick material (having large particles sizes). The thick material is the sand-free manure liquid, which might be transported to a storing tank and used for biogas and the thin material may be transported into the flush water tank and can then be reused for diluting the raw manure to reach a required dry matter percentage.

In the tank for processing the mixture of sand and manure liquid, the mixture still includes some manure liquid and organic matters. During the treating and washing of the mixture in the tank, the manure liquid and organic matters moves across the overflow edge of the tank and is transported back to the raw manure tank from where the raw stream of sand mixed with manure liquid was pumped from in the first place (the raw manure tank).

In one or more embodiments of the first or second aspect, the through-going passage having a circular cross-section, wherein preferably the cross-section of the through-going passage is adjustable by the first clamping body to assume a diameter in the range of 25 to 55 mm, such as in the range of 30 to 50 mm, such as in the range of 32 to 48 mm, such as in the range of 34 to 44 mm.

In one or more embodiments of the first or second aspect, the adjustment command is defined based on desired degree of separation of the raw stream of sand mixed with manure liquid. By the desired degree of separation is also meant desired retention rate. Degree of separation is a measure for how much of the sand present in the raw stream of sand mixed with manure liquid that can be separated from the manure liquid.

It is an advantage of the present invention that most of the sand from the raw stream of sand mixed with manure liquid is able to be reused. In one or more embodiments of the first or second aspect, the desired degree of separation is 95% by weight or more or such as 97% by weight or more. Hence, by the present invention it is assured that at least 95%, or at least 97% by weight or more of the sand is able to be reused for bedding material for the animals in the stables or barns. For the farmer, it is an economic benefit to be able to reuse as much sand as possible.

In one example, the washed sand does not contain more than a maximum of 3% by weight of organic matter. By keeping the amount of organic matter low in the washed sand, the sand will by more dry since water binds to the organic matter present and hence, the risk of bacterial growth in the sand will also be minimized.

Hence, a good quality of the washed sand is of major importance for the farmer, since having good bedding material for the animals in the stables or barns is increasing the life-quality for the animals.

The sand-free manure liquid, which might be transported to a storing tank and used for biogas, may have a dry matter in the range from 6 to 8% by weight.

The sand-free manure liquid which might be transported to a storing tank and used for biogas, may have above 75% or above 78% or above 80% by weight of organic matter.

In one example, the mixture including sand where 90% by weight or more, such as 95% by weight or more has a grain size of between 90 microns to 350 microns, such as 100 micron to 300 microns.

The washed sand-the sand particles-will in one or more examples have a size (grain size) in the range of 90 to 350 microns or such as in the range of 100 to 300 microns. The washed sand-the sand particles-will in one or more examples have a size above 125 micron. It is known that a smaller grain size of the sand improves the animal welfare in that smaller size sand grains are more comfortable to lie on for the animal.

In one or more embodiment of the first or second aspect, the adjustment command can be a process value measured in the system. Various parameters (process values) can therefore influence the degree of separation.

In one or more embodiments of the first or second aspect, the adjustment command is based on a measured value of the dry matter in the raw stream of sand mixed with manure liquid. Hence, the process value could in one example be the dry matter as measured by a dry matter meter.

The dry matter meter may be placed in connection with the pipe connection positioned between the raw manure tank and the cyclone. Hence, the dry matter meter may be placed before the inlet to the pre-separator. In one example, the weight value (in weight %) of the dry matter might be in the range from 3.0 to 5.0, such as in the range of 3.4 to 4.4, or such as in the range of 3.6 to 4.0. The dry matter of the raw stream of sand mixed with manure liquid may be controlled and adjusted by diluting the raw stream of sand mixed with manure liquid with the material from the flush water tank. In one or more examples, the dry matter of the raw stream of sand mixed with manure liquid is adjusted to be in the range of 3.6 to 4.0% by weight, or approximately 3.8% by weight. The raw manure in the raw manure tank including a mix of livestock excreta and urine and other organic matter and sand collected from one or more stables and led to the raw manure tank may have a dry matter in the range from 7 to 18% by weight.

The cross-section of the through-going passage of the flow restriction portion, may then be adjusted accordingly to the weight value (in weight %) of the dry matter. If the dry matter as measured is in the high range, then the cross-section of the through-going passage will be adjusted to be in the higher range. If the dry matter as measured is in the low range, then the cross-section of the through-going passage will be adjusted to be in the low range. In one example, if a dry matter of 4.0 is measured, the cross-section of the through-going passage may be adjusted to be in the higher range, e.g., 46 mm, whereas if a dry matter of 3.6 is measured, the cross-section of the through-going passage may be adjusted to be in the lower range, e.g., 32 mm. The value of the dry matter measured also gives information about the viscosity of the raw stream of sand mixed with manure liquid.

In one or more embodiments of the first or second aspect, the adjustment command is based on flow as measured by a flow meter for registering a second flow of material from the cyclone. The second flow may in one or more embodiments be the flow of material rejected upwards by the cyclone.

Hence, in one or more embodiments, the sand-manure liquid separation plant includes a flow meter for registering the flow of the material rejected upwards by the cyclone. The flow meter may be placed in connection with the pipeline leading the material rejected upwards by the cyclone to the rotary screen filter. The material being the majority of the manure liquid part of the raw stream of sand mixed with manure liquid and the majority of the organic matters of the raw stream of sand mixed with manure liquid. Hence, in one or more embodiments, the process value could be the flow as measured by the flow meter for registering the flow of the material rejected upwards by the cyclone.

In one or more examples, between 45 to 60% of the incoming flow will be rejected upwards by the cyclone. In one or more examples, the second flow of material from the cyclone may vary a bit. In one or more examples, the variation is within the range of 0.1 to 0.4 m³/hour. This may, at least partly, be due to the material properties of the flow restriction portion of the outlet portion and/or the internal shape or design of the flow restriction portion of the outlet portion.

In one or more embodiments of the first or second aspect, the adjustment command is based on flow as measured by a flow meter for registering a flow of the raw stream of sand mixed with manure liquid into the cyclone. In one or more embodiments, the sand-manure liquid separation plant includes a flow meter for registering the flow of the raw stream of sand mixed with manure liquid into the cyclone. Hence, the process value could in one example be the flow of the raw stream of sand mixed with manure liquid into the cyclone as measured by a flow meter. The flow meter may be placed in connection with the pipe connection positioned between the raw manure tank and the cyclone. Hence, the flow meter may be placed before the inlet to the pre-separator. In one or more examples, the flow of the raw stream of sand mixed with manure liquid into the cyclone as measured by a flow meter may be in the range of 22 to 30 m³/hour. In one or more examples, the flow of the material rejected upwards by the cyclone may be in the range of 10 to 18 m³/hour.

In one or more embodiments of the first or second aspect, the adjustment command is based on pressure as measured by an apparatus for measuring pressure (a pressure transmitter) for registering a pressure of the raw stream of sand mixed with manure liquid inflow to the cyclone. In one or more examples, the pressure of the raw stream of sand mixed with manure liquid inflow to the cyclone is in the range of 0.7 to 1 bar, such as in the range of 0.8 to 0.9 bar.

In one or more embodiments, the sand-manure liquid separation plant includes an apparatus for measuring the pressure (a pressure transmitter) of the raw stream of sand mixed with manure liquid inflow to the cyclone. Hence, in one or more embodiments, the process value could be the pressure as measured by the apparatus for measuring the pressure.

In one or more embodiments of the first or second aspect, the flow restriction portion is attached to the cyclone. In one or more embodiments of the first or second aspect, the flow restriction portion is being integrated into the cyclone.

In one or more embodiments of the first or second aspect, the flow restriction portion being of a resilient material is manufactured in a durable elastic material. The material needs to be durable against the wear and tear from sand but at the same time flexible enough to be able to being pressed together to adjust the cross-section of the through-going passage. In one or more embodiments of the first or second aspect, the flow restriction portion is manufactured in an abrasion resistant polymeric material. In one or more embodiments of the first or second aspect, the flow restriction portion of the outlet portion is manufactured in a polyurethane material having a shore hardness value (shore A) in the range of 30 to 90, such as in the range of 50 to 80, such as in the range of 50 to 70, such as around 60.

The hardness of plastic materials, typically polymers, elastomers and rubbers, can be measured on a shore hardness scale, which measures the resistance of a material to indentation. The hardness may be tested using a durometer device. In the present disclosure, the shore A scale is used for measuring the hardness. A higher number indicates greater resistance to indentation so therefore a harder material. Softer materials are lower on the scale.

In one or more embodiments of the first or second aspect, the cyclone is manufactured in a polyurethane material having a shore hardness value (shore A) in the range of 80 to 100. In one or more embodiments of the first or second aspect, the cyclone is having a shore hardness value of 90. By having the cyclone made in polyurethane material having a shore hardness value of 90 it is assured that the material can resist the wear that will results from the sand material-manure liquid mixture being processed and separated in the cyclone.

In one or more embodiments of the first or second aspect, a second clamping body having an adjustable cross-section and engaging an outer periphery of the first clamping body is present.

In one or more embodiments of the first or second aspect, the first clamping body and/or the second clamping body being configured to provide a uniform, or substantially uniform, radial pressure against the outer periphery of the flow restriction portion.

In one or more embodiments of the first or second aspect, the first clamping body and/or the second clamping body being a substantially ring-shaped clamping body or a segmented clamping body. In one or more embodiments of the first or second aspect, it could be a clamping body defined by a plurality of radially inwardly moving segment driven inwardly by the actuator which serves to rotate an outer disc engaging engaging-portions defined by faces on the segments. In another embodiment, the clamping body could be a structure operating in the manner of an iris valve (which does not close fully), such as by including a series of leaves or vanes which rotate in from the outer edge of a circular opening towards a center or in the form of an iris diaphragm, or a similar mechanism that can vary the diameter of the through-going passage of the flow restriction portion. Thereby it can be obtained that the through-going passage during the size regulation maintain a circular geometry.

In one or more embodiments of the first or second aspect, the first clamping body and/or the second clamping body may be made in a hard durable material such as stainless steel.

In one or more embodiments of the first or second aspect, the first clamping body being manufactured of a polymeric material and preferably including a plurality of first segments interconnected by a plurality of thin walled second segments. When the first clamping body is providing a pressure against the outer periphery of the flow restriction portion the thin walled segments is able to bulge.

In one or more embodiments of the first or second aspect, the first clamping body is manufactured in a polyurethane material having a shore hardness value (shore A) in the range of 70 to 100, such as in the range of 60 to 90, such as in the range of 70 to 90. In one or more embodiments, the first clamping body is having a shore hardness value of 80. By having the first clamping body made in polyurethane material having a shore hardness value of 80 it is assured that the material can resist the wear that will results from repetitive movements.

In one or more embodiments, the tank further includes a stirrer. The stirrer may be a rotary stirrer. In one or more embodiments, the stirrer is rotating about a central axis of the tank. A stirrer preferably serves to stir settled sand such that any impurities remaining on the surface of the grains of sand will raise to the surface of the manure liquid, normally driven by an upward flow of water supplied at the bottom of the tank.

In one or more embodiments of the plant, the sand discharge communicates with at least one upwardly extending screw conveyor.

In one or more embodiments of the plant, the bottom portion further includes a number of water inlets for supplying fresh water under pressure to the tank. The water inlets are configured for providing an upward flow of the supplied fresh water in the tank.

In one or more embodiments of the plant, the tank having a liquid outlet arranged at a level of the tank defining a maximum level of filling of the mixture in the tank, and wherein the mixture inlet for introducing the mixture into the tank is arranged at a level above the liquid outlet. In one or more embodiments, the maximum level (ML) of filling is being defined by a level of overflow of the mixture in the tank. Hence, in one or more embodiments, the liquid outlet includes the overflow.

In one or more embodiments of the plant, the plant including a source of a fluid and a number of fluid outlets arranged above the maximum level and connected to the source of a fluid, the outlets being configured to provide a flow of the fluid directed towards the maximum level.

In one or more embodiments of the plant, the fluid being fresh water. In one or more embodiments of the plant, the fluid includes a surfactant.

In a third aspect is disclosed the use of the cyclone according to the present disclosure in a sand-manure liquid separation plant, the plant including a tank for processing a mixture of sand and manure liquid; the tank including:
a top portion including a mixture inlet for introducing the mixture into the tank,
a bottom portion including a sand discharge,
   wherein the plant further includes a pre-separator for a raw stream of sand mixed with manure liquid, the cyclone defining the pre-separator, a tubular outlet portion of the cyclone at a bottom part of the cyclone being arranged at the top portion of the tank for the mixture leaving the cyclone to be processed in the tank to flow into the tank by gravity via the mixture inlet.

In one or more embodiments of the use, the sand-manure liquid separation plant is as disclosed herein.

In one or more embodiments of the use, 90% by weight or more, such as 95% by weight or more of the sand in the mixture has a grain size of between 100 micron to 300 microns.

In a fourth aspect is also disclosed a method of operating the plant according to the present disclosure, the method including the steps of:
measuring:
   a value of the dry matter of the raw stream of sand mixed with manure liquid, and/or
   flow as measured by a flow meter for registering a second flow of material from the cyclone, and/or
   flow as measured by a flow meter of the raw stream of sand mixed with manure liquid into the cyclone;
sending an adjustment command from the control unit to the actuator based on the measurements;
the actuator adjusting the first clamping body to vary the cross-section of the through-going passage of the flow restriction portion thereby adjusting the output flow of the mixture into the tank.

### BRIEF DESCRIPTION OF FIGURES

FIG. 1A shows a general overview of an embodiment of a sand-manure liquid separation plant in accordance with the present invention, with a general description of some key elements;

FIG. 1B shows, seen from the side, a tank element and a sand discharge element of the sand-manure liquid separation plant of FIG. 1A;

FIG. 1C is a top view of the tank element and sand discharge element shown in FIG. 1B;

FIG. 1D shows a cross-section, at line E-E, of the tank element and sand discharge element of FIG. 1C;

FIG. 2 shows a cyclone of the plant of FIG. 1A in accordance with the present invention;

FIG. 3 shows a flow restriction portion of the cyclone of FIG. 2, with a two-part clamping body;

FIGS. 4A-B shows the flow restriction portion of FIG. 3, where FIGS. 4A and 4C show the flow restriction portion in a non-compressed state in a compressed state, in a cross-sectional view and from an end, respectively, and where FIGS. 4B and 4D show the flow restriction portion in a compressed state, in a cross-sectional view and seen from an end, respectively;

FIGS. 5A-D show the flow restriction portion of FIG. 3 engaged by two surrounding clamping bodies; and

FIGS. 6A-C show the portion of the tank marked with a broken line circle in FIG. 1D, seen from above (FIG. 6A) and in two cross-sectional side views (FIGS. 6B-6C) representing a respective embodiment.

### DETAILED DESCRIPTION OF THE INVENTION

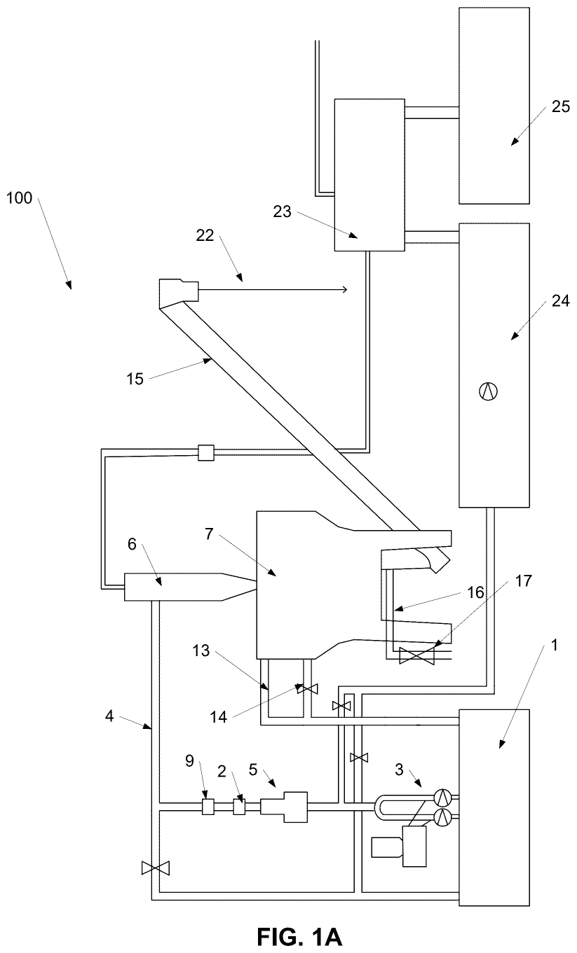

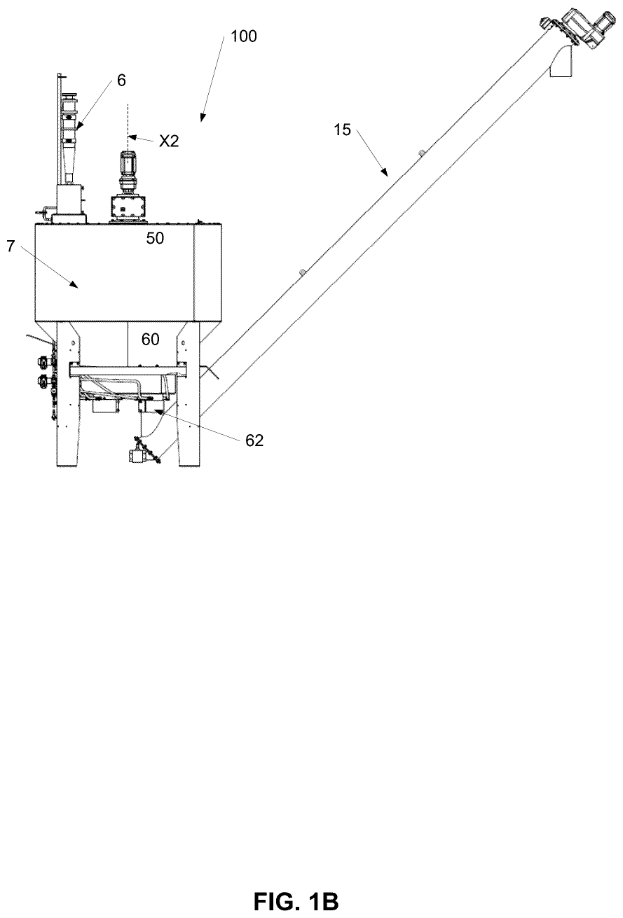

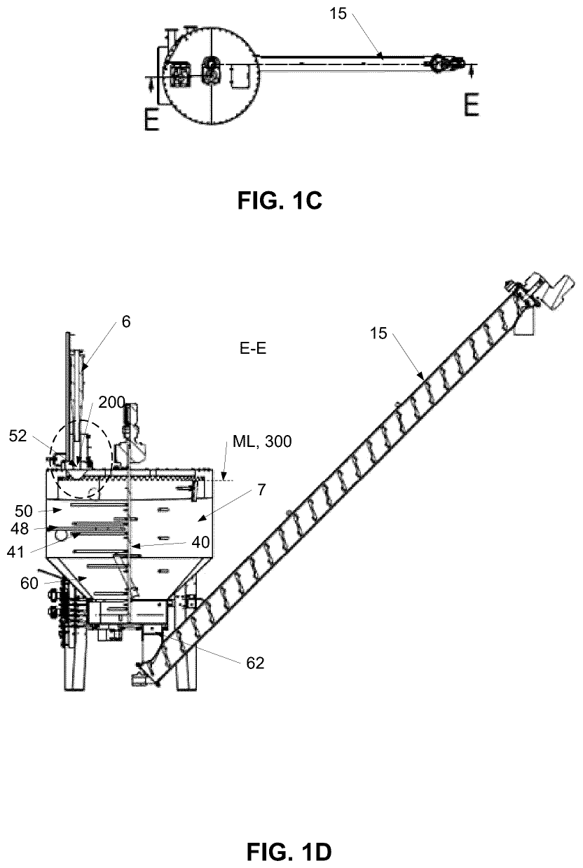

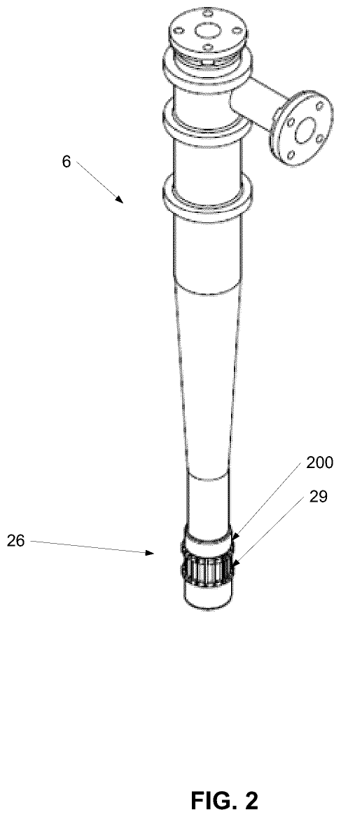

In the plant 100 shown in FIG. 1A, a raw stream of sand mixed with manure liquid or a slurry including a mix of livestock excreta and urine is collected from one or more stables and led to a tank 1 for “raw manure”. This tank 1 is provided with a powerful agitator to ensure a thorough mixing of slurry and sand before it is pumped further in the plant by a raw slurry pump 3. The raw stream of sand mixed with manure liquid may be mixed with water (from a flush water tank 24 to reach a required dry matter percentage).

The raw slurry pump 3 can by advantage be one or more positive displacement pumps, such as piston pumps. In an advantageous embodiment of such positive displacement pumps 3, the pump 3 includes two cylinders and two pistons, where the time when each of the pistons is at its peak (top dead center or TDC) is displaced and that the return stroke of the pistons is controlled so that when the first piston delivers its maximum pressure, the second piston has already started to build up pressure, but at a lower level. When the first piston passes its top dead center, it quickly returns to its bottom dead center in order to start building pressure already when the second piston delivers its maximum pressure. This results in a pump 3 where there are no major fluctuations in pump pressure during a pump cycle.

In a pipeline leading the raw stream of sand mixed with manure liquid further in the plant is provided a macerator 5 which ensures the comminution of coarse dry matter parts and separates foreign objects such as stones, cow teeth, hooves or parts of hooves, ear tags, patches, bandages or large pieces of wood. Hereby it is ensured that such larger particles as mentioned before, are disintegrated so that they do not clog the plant and cause unnecessary downtime. The pipeline 4, also referred to as a connecting pipe, may include a dry matter meter 2 and a flow meter 9.

The pipeline 4 leads the raw stream of sand mixed with manure liquid into a cyclone 6 for pre-separation and then the mixture gravitates into the tank for processing the mixture 7. The raw stream of sand mixed with manure liquid containing organic material is pumped into the cyclone 6 via a tangential inlet and through the cyclone 6 into a top portion of the tank.

In the cyclone 6, the sand material is pre-separated from the manure liquid or slurry by the function of the cyclone 6 and the difference in density between sand and liquid. The cyclone 6 can control and sort the particles based on the particle mass. In one or more embodiments, the particle mass can be controlled down to 1 to 2 grams. The part of the liquid that is free of sand is forced out through the top of the cyclone 6, while the rest with the heavier sand flows out through the outlet portion of the cyclone 6 at a bottom part of the cyclone 6.

A slow-moving rotary stirrer is mounted inside the tank 7, which separates sand and organic matter. The rotary stirrer is shown in FIG. 1D. The rotary stirrer includes a plurality of curved arms extending from at substantially vertical rotational axis and can have different embodiments showing different number of arms, having different lengths, having different diameters and having different curvatures.

The sand settles at the bottom of the tank 7. The sand-free manure liquid (residual slurry) with the organic material remains at the top of the tank 7 and flows out through the outlet 13 of the tank, via an overflow, and is transported back to the raw manure tank 1. A pipeline 14 including a valve may be used for removing residuals and/or sludge that would otherwise clog the tank. The valve can be opened when needed, often 2 to 3 times a day depending on the need.

The level of sand at the bottom of the tank 7 will increase during operation. This will increase the resistance of the rotary stirrer. When the load on a gear motor driving the stirrer reaches a certain upper level, one or more screw conveyors 15 will operate in an on/off setting. The moment less sand is supplied than is transported away via the screw conveyors 15, the load on the stirrer gear motor will decrease and when a predetermined lower level is reached, the screw conveyors 15 will stop. Each sand-manure liquid separation plant can include between 1 to 4 screw conveyers, and each screw conveyer can process up to 1500 kg sand per hour, e.g. in the interval between 800 to 1000 kg.

At the bottom of the tank 7 there is a rinsing water arrangement 16 which makes it possible to rinse the sand continuously with water, so that organic material is washed out and the sand cleaned. Upon an external start signal, the tank's 7 water valve 17 opens. The water valve 17 is open until the flow is above the minimum flow sensor setpoint. If the pressure of the water changes so that the pressure drops and the flow falls below the minimum, the valve 17 opens further to maintain the desired flow. If the pressure increases so that the flow reaches the sensor for maximum flow, the valve 17 will close so that the flow falls below the maximum.

Sand 22 being discharged from the one or more screw conveyors 15 ends in a container or a pile and when the sand is sufficiently dry, it can be used for bedding material again. In one or more embodiments, the washed sand contains less than 3% by weight of organic matters.

Manure liquid and organic materials, rejected upwards by the cyclone 6, are transported to a rotary screen filter 23, also called a drum screen, where the thin materials are mechanically separated from the thick materials. The thick medium is sand-free manure liquid, which can be used for biogas, is transported to a tank 25 for manure liquid free of sand. The thin material is transported into the flush water tank 24 and is used for diluting the raw manure in the raw manure tank 1.

FIG. 2 shows the cyclone 6. The cyclone 6 has an outlet portion 26 at a bottom part of the cyclone 6 including the flow restriction portion 200. At the top of the cyclone 6, an inlet leads the raw stream of sand mixed with manure liquid containing organic material into the cyclone 6. In the cyclone 6, the sand material is pre-separated from the manure liquid or slurry by the function of the cyclone 6 and the difference in density between sand and liquid. The cyclone 6 can control and sort the particles based on the particle size. The part of the liquid that is free of sand is forced out through an outlet at the top of the cyclone 6, while the rest with the heavier sand flows out through the outlet portion of the cyclone at a bottom part of the cyclone. The liquid that is free of sand being rejected upwards by the cyclone will be transported to a drum screen for mechanical separation. A clamping body 29 is engaging the outer periphery of the flow restriction portion 200.

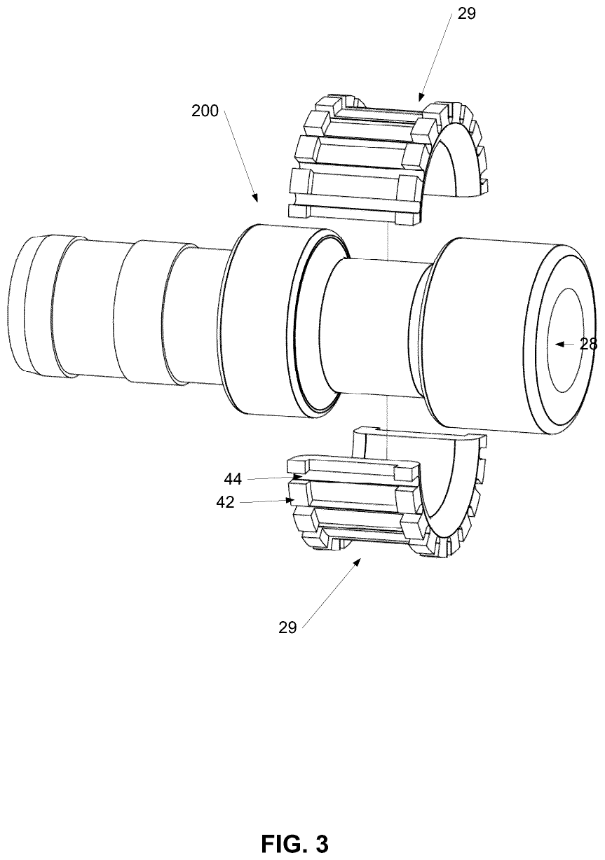

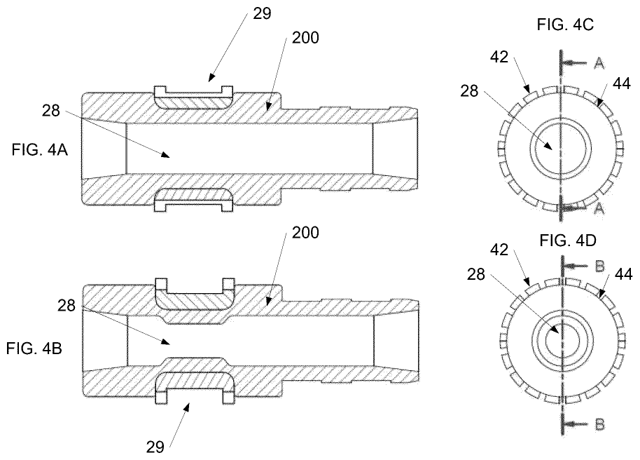

FIGS. 3 and 4A-4D shows the flow restriction portion 200 in greater details, where FIGS. 4A and 4C show the flow restriction portion 200 in a non-compressed state, and where FIGS. 4B and 4D show the flow restriction portion 200 in a compressed state.

The clamping body 29 is engaging the outer periphery of the flow restriction portion 200, the clamping body 29 being adjustable to vary the cross-section of the through-going passage 28 of the flow restriction portion. The clamping body 29 is enclosing the flow restriction portion 200 during operation. In the embodiment shown in these figures, the clamping body 29 is made of a polymeric material and includes a plurality of first segments 42 interconnected by a plurality of thin walled second segments 44. When the clamping body is providing a pressure against the outer periphery of the flow restriction portion the thin walled segments is able to bulge.

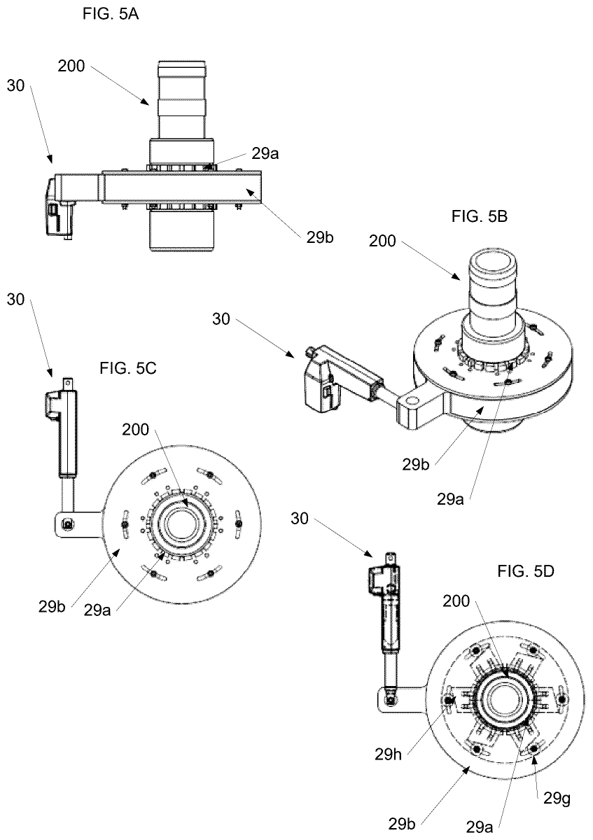

However, in one or more embodiments, the clamping body could also be a segmented clamping body. In one or more embodiments the clamping body could be a clamping body defined by a plurality of radially inwardly moving segment driven inwardly by the actuator which serves to rotate an outer disc engaging engaging-portions defined by faces on the segments (as detailed in FIGS. 5A-5D). In another embodiment, the clamping body could be a structure operating in the manner of an iris valve (which does not close fully), such as by including a series of leaves or vanes which rotate in from the outer edge of a circular opening towards a center or in the form of an iris diaphragm, or a similar mechanism that can vary the diameter of the through-going passage of the flow restriction portion. The through-going passage 28 is having a circular cross-section, wherein the cross-section of the through-going passage is adjustable to assume a diameter in the range of 25 to 55 mm, such as in the range of 30 to 50 mm, such as in the range of 32 to 48 mm, such as in the range of 34 to 44 mm. The clamping body 29 may optionally be removable from the outlet portion 26 and replaceable.

FIGS. 5A, B, C, and D shows the flow restriction portion 200, where in these figures two clamping bodies are engaging the outer periphery of the flow restriction portion 200—clamping body 29a and 29b. FIG. 5A is a view from the side, FIG. 5B is an isometric view, and FIG. 5C is a top view, where FIG. 5D is a cross section of the top view. In these figures and FIGS. 4A-4D, a clamping body 29a including a plurality of first segments 42 interconnected by a plurality of thin walled second segments 44 engage the outer periphery of the flow restriction portion 200. The clamping body 29a may be made of a polymeric material. Further, a clamping body 29b—defined by a plurality of radially inwardly moving segment 29h driven inwardly by the shown linear actuator 30 which serves to rotate an outer disc 29g engaging engaging-portions defined by slanted faces on the segments 29h such that the linear motion of the actuator 30 brings about the radial movement of the segments 29h so as to provide a radially inwardly directed clamping force against either the outer periphery of the aforementioned clamping body 29a, if present, or directly against the outer periphery surface of the flow restriction portion. Alternatively, the clamping body 29b could in another embodiment by a structure operating in the manner of an iris valve (which does not close fully), such as by including a series of leaves or vanes which rotate in from the outer edge of a circular opening towards a center or in the form of an iris diaphragm, or a similar mechanism that can vary the diameter of the through-going passage of the flow restriction portion. The clamping body may be made in a hard durable material. The segmented clamping body is especially good at maintaining an even circular geometry of the through-going passage during the adjustment of the clamping body 29b. The clamping body 29b is connected to an actuator 30. The adjustment of the clamping body 29b follows an adjustment command send by a control unit to the actuator 30, thereby adjusting the output flow of mixture into the tank.

In one or more embodiments, the clamping body 29a including a plurality of first segments 42 interconnected by a plurality of thin walled second segments 44 engaging the outer periphery of the flow restriction portion 200 could be left out, so that only the segmented clamping body 29b is engaging the outer periphery of the flow restriction portion 200.

The adjustment command may be based on desired degree of separation of the raw stream of sand mixed with manure liquid of at least 95% by weight or more, or such as 97% by weight or more. The adjustment command may be based on a measured value of the dry matter in the raw stream of sand mixed with manure liquid, flow as measured by a flow meter for registering a flow of material rejected upwards from the cyclone, flow as measured by a flow meter for registering a flow of the raw stream of sand mixed with manure liquid into the cyclone and/or pressure as measured by an apparatus for measuring pressure (a pressure transmitter) for registering a pressure of the raw stream of sand mixed with manure liquid inflow to the cyclone.

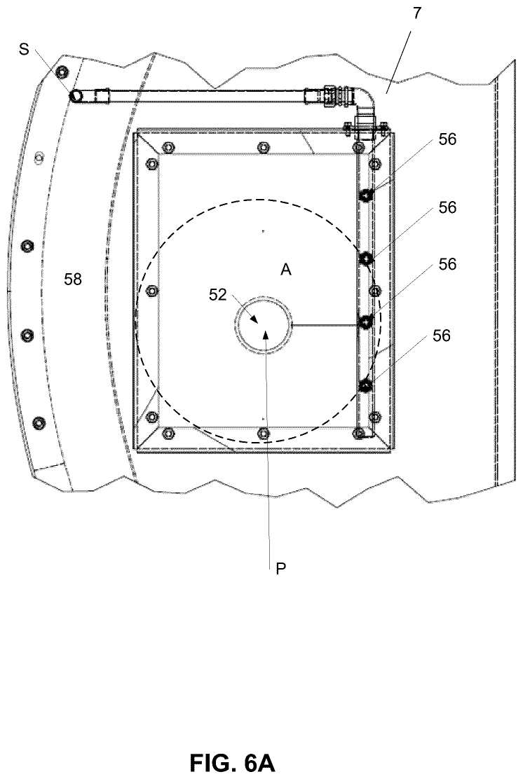

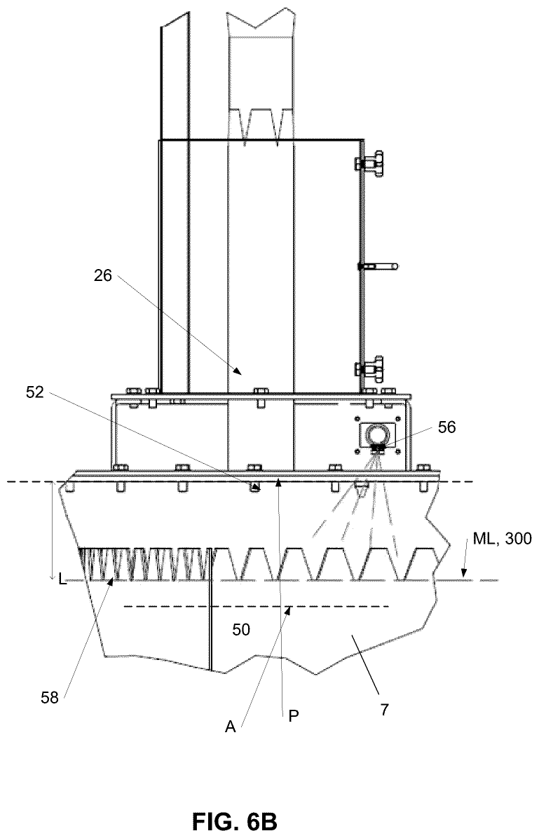

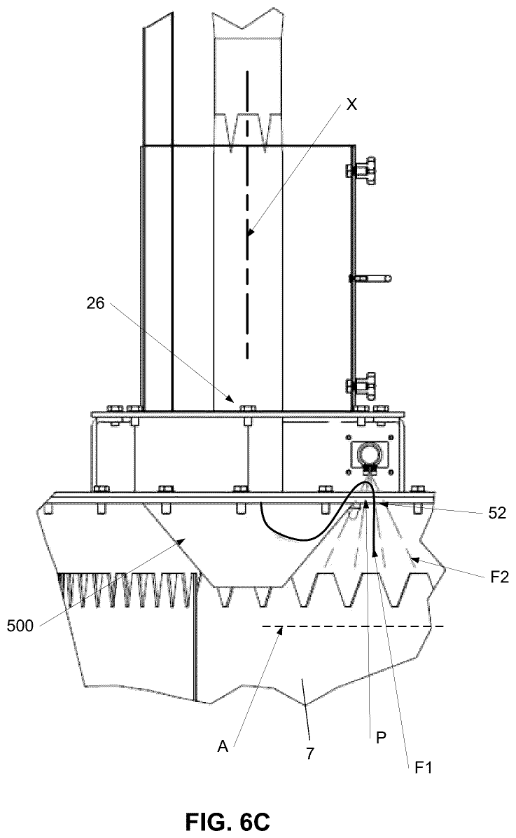

FIGS. 6A-6C show details of a plant according to the invention, incorporating two differently configured mixture inlets 52. As shown, the tank 7 generally has in its top portion 50 a mixture inlet 52 for filling the mixture to be processed into the tank 7, and the aforementioned bottom portion including the sand discharge.

The tank 7 also includes structure for defining a maximum level ML of filling of the mixture within the tank 7, such as in the way of a circular gutter 58 mounted to the inside periphery of the tank wall. The mixture inlet 52 is arranged at a general position P relative to the peripheral wall of the tank, at a height L above the maximum level ML of filling.

Moreover, the tank 7 of the plant further includes a number of fluid outlet(s) 56 that are connected to a source S, such as a fluid container or a fresh water supply, of a fluid, and that are also arranged at a level or height above the maximum level ML of filling. In operation, the fluid outlets 56 deliver a flow of the aforementioned fluid generally directed, by properly orienting the fluid outlets 56, towards pre-determined portions of the surface 300 of the mixture in the tank, which level normally corresponds to the maximum level ML, below the position P of the mixture inlet 52.

Where, as shown, the plant 100 includes a pre-separator cyclone 6 as discussed above, the mixture to be processed in the tank 7 flows into the tank 7 by gravity via the cyclone outlet portion 26 and the mixture inlet 52, the latter typically including an aperture formed in a shielded part of a cover of the tank 7, in which shielded part the cyclone outlet portion 26 connects to the mixture inlet 52.

As shown in FIGS. 6B and 6C, the one or more fluid outlet(s) 56 are arranged adjacent the mixture inlet 52 such that fluid discharged from the fluid outlets 56 will strike the surface 300 where also mixture filled into the tank 7 via the mixture inlet hits the surface 300, i.e., in an area shown generally by letter A.

In one embodiment shown in FIG. 6C the mixture inlet 56 includes a bowl-shaped body 500 placed below the aforementioned aperture so as to directly receive the flow of incoming mixture, which flow is then discharged further through an annular passage extending around at least a portion of the bowl-shaped body 500, to flow around the annular outer periphery of the bowl-shaped body and then cascade annularly into the tank in a somewhat annular portion A of the surface 300, of which a portion is shown in FIG. 6C. The bowl-shaped body 500 dampens the incoming flow of the mixture where desired.

FIG. 6B shows an alternative embodiment without any such flow dampening body 500 and, hence, where the incoming flow of the mixture is discharged directly onto a generally circular portion of the surface 300, as seen also in FIG. 6A. The two embodiments have in common the aforementioned fluid outlet(s) 56 that are arranged such that fluid discharged from the fluid outlets 56 will strike that portion A of the surface 300 where also mixture filled into the tank 7 via the mixture inlet 52 hits the surface 300. This results in a breaking-up of the surface 300, i.e. to eliminate the tendency of the mixture to behave as if its surface were covered with a stretched elastic membrane reflecting what is often used to describe the effect of surface tension.

This “breaking-up” is of particular importance where fine sand is used by the farmer as bedding, which fine sand may be defined as a sand fraction where 90% by weight or more, such as 95% by weight or more of the sand has a grain size between 100 micron and 300 micron, since such fine sand may otherwise tend to remain on the surface 300 of the mixture in the tank, thus delaying the rate of settling of the sand within the bottom part of the tank 7.

While the aforementioned fluid may be a gas, such as compressed air, or a liquid containing a surfactant, it is preferred to use water, in particular fresh water typically available at farms, the fluid outlets 56 being configured to inject the fluid into the mixture.

In use, the plant is operated by filling into the tank 7 the mixture, where 90% by weight or more, such as 95% by weight or more of the sand has a grain size of between 100 micron and 300 micron and providing during the filling, or for a substantial time during the filling, a flow of the fluid into the tank 7, oriented towards a part of the surface 300 of the mixture in the tank 7 below the mixture inlet 52, and discharging continuously or intermittently the settled sand from the tank (7). The flow of the fluid into the mixture is preferably provided when the surface 300 of the mixture is at the maximum level ML.

In the followings various items of the invention is disclosed.
1. A sand-manure liquid separation plant (100) including a tank (7) for processing a mixture of sand and manure liquid; the tank including:
a top portion (50) including a mixture inlet (52) for introducing the mixture to be processed into the tank,
a bottom portion (60) including a sand discharge (62),
wherein
   the plant further includes a pre-separator for a raw stream of sand mixed with manure liquid, the pre-separator including a cyclone (6), a tubular outlet portion (26) of the cyclone at a bottom part of the cyclone being arranged at the top portion of the tank for the mixture leaving the cyclone to be processed in the tank to flow into the tank by gravity via the mixture inlet,
   the outlet portion of the cyclone including a flow restriction portion (200) being of a resilient material and having a through-going passage (28) for the mixture,
   the plant including a control unit to control an output flow from the cyclone of the mixture to be introduced into the tank via the through-going passage,
   a first clamping body (29) engaging an outer periphery of the flow restriction portion, the first clamping body being adjustable to vary the cross-section of the through-going passage of the flow restriction portion, the first clamping body optionally being removable from the outlet portion and replaceable.
2. The plant according to item 1, wherein the adjustment of the first clamping body follows an adjustment command send by the control unit to an actuator (30), thereby adjusting the output flow of the mixture into the tank.
3. The plant according to items 1 or 2, wherein the through-going passage having a circular cross-section, wherein preferably the cross-section of the through-going passage is adjustable by the first clamping body to assume a diameter in the range of 25 to 55 mm, such as in the range of 30 to 50 mm, such as in the range of 32 to 48 mm, such as in the range of 34 to 44 mm.
4. The plant according to any of the preceding items 2 to 3, wherein the adjustment command is defined based on desired degree of separation of the raw stream of sand mixed with manure liquid of at least 95% by weight or more, or such as 97% by weight or more.
5. The plant according to any of the preceding items 2 to 4, wherein the adjustment command is based on a measured value of the dry matter in the raw stream of sand mixed with manure liquid.
6. The plant according to any of the preceding items 2 to 5, wherein the adjustment command is based on flow as measured by a flow meter (9) for registering a second flow of material from the cyclone.
7. The plant according to any of the preceding items, wherein at least the flow restriction portion of the outlet portion is manufactured of a polyurethane material having a shore hardness value (shore A) in the range of 30 to 90, such as in the range of 50 to 80, such as in the range of 50 to 70, such as around 60.
8. The plant according to any of the preceding items, further including a second clamping body (29) having an adjustable cross-section and engaging an outer periphery of the first clamping body.
9. The plant according to any of the preceding items, wherein the first clamping body and/or the second clamping body being configured to provide a uniform, or substantially uniform, radial pressure against the outer periphery of the flow restriction portion.
10. The plant according to the preceding item 9, wherein the first clamping body and/or the second clamping body being a substantially ring-shaped clamping body or a segmented clamping body, such as a structure operating in the manner of an iris valve such as by including a series of leaves or vanes which rotate in from the outer edge of a circular opening towards a center.
11. The plant according to any of the preceding items, wherein the first clamping body being manufactured of a polymeric material and preferably including a plurality of first segments (42) interconnected by a plurality of thin walled second segments (44).
12. The plant according to any of the preceding items, wherein the first clamping body is manufactured of a polyurethane material having a shore hardness value (shore A) in the range of 60 to 90, such as in the range of 70 to 90, such as around 80.
13. The plant according to any of the preceding items, wherein the sand discharge communicates with at least one upwardly extending screw conveyor (15).
14. The plant according to any of the preceding items wherein the bottom portion further includes a number of water inlets (16) for supplying fresh water under pressure to the tank.
15. The plant according to any of the preceding items, wherein the tank having a liquid outlet arranged at a level of the tank defining a maximum level (ML) of filling of the mixture in the tank, and wherein the mixture inlet for introducing the mixture into the tank is arranged at a level above the liquid outlet.
16. The plant according to item 15, wherein the plant including a source of a fluid and a number of fluid outlets (58) arranged above the maximum level and connected to the source of a fluid, the outlets being configured to provide a flow of the fluid directed towards the maximum level.
17. The plant according to item 15, wherein the fluid being fresh water.
18. A cyclone (6) including a tubular outlet portion (26), where the outlet portion including a flow restriction portion (200) being of a resilient material having a through-going passage (28), a first clamping body (29) engaging an outer periphery of the flow restriction portion, the first clamping body being adjustable to vary the cross-section of the through-going passage of the flow restriction portion, the first clamping body optionally being removable from the outlet portion and replaceable.
19. The cyclone according to preceding item 18, wherein the adjustment of the first clamping body follows an adjustment command send by a control unit to an actuator (30), thereby adjusting the output flow of the mixture into the tank.
20. The cyclone according to preceding items 18 or 19, wherein the through-going passage having a circular cross-section, wherein preferably the cross-section of the through-going passage is adjustable by the first clamping body to assume a diameter in the range of 25 to 55 mm, such as in the range of 30 to 50 mm, such as in the range of 32 to 48 mm, such as in the range of 34 to 44 mm.
21. The cyclone according to any of the preceding items 19 to 20, wherein the adjustment command is defined based on desired degree of separation of a raw stream of sand mixed with manure liquid of at least 95% by weight or more, or such as 97% by weight or more.
22. The cyclone according to any of the preceding items 19 to 21, wherein the adjustment command is based on a measured value of the dry matter in a raw stream of sand mixed with manure liquid.
23. The cyclone according to any of the preceding items 19 to 22, wherein the adjustment command is based on flow as measured by a flow meter for registering a second flow of material from the cyclone.
24. The cyclone according to any of the preceding items 18 to 23, wherein at least the flow restriction portion of the outlet portion is manufactured of a polyurethane material having a shore hardness value (shore A) in the range of 30 to 90, such as in the range of 50 to 80, such as in the range of 50 to 70, such as around 60.
25. The cyclone according to any of the preceding items 18 to 24, further including a second clamping body (29) having an adjustable cross-section and engaging an outer periphery of the first clamping body.
26. The cyclone according to any of the preceding items 18 to 25, wherein the first clamping body and/or the second clamping body being configured to provide a uniform, or substantially uniform, radial pressure against the outer periphery of the flow restriction portion.
27. The cyclone according to the preceding item 26, wherein the first clamping body and/or the second clamping body being a substantially ring-shaped clamping body or a segmented clamping body, such as a structure operating in the manner of an iris valve, such as by including a series of leaves or vanes which rotate in from the outer edge of a circular opening towards a center.
28. The cyclone according to any of the preceding items 18 to 27, wherein the first clamping body being manufactured of a polymeric material and preferably including a plurality of first segments interconnected by a plurality of thin walled second segments.
29. The cyclone according to any of the preceding items 18 to 28, wherein the first clamping body is manufactured of a polyurethane material having a shore hardness value (shore A) in the range of 60 to 90, such as in the range of 70 to 90, such as around 80.
30. Use of the cyclone (6) according to item 18 to 29, in a sand-manure liquid separation plant (100), the plant including a tank (7) for processing a mixture of sand and manure liquid; the tank including:
a top portion (50) including a mixture inlet (52) for introducing the mixture into the tank,
a bottom portion (60) including a sand discharge (62),
wherein the plant further includes a pre-separator for a raw stream of sand mixed with manure liquid, the cyclone defining the pre-separator, a tubular outlet portion (26) of the cyclone at a bottom part of the cyclone being arranged at the top portion of the tank for the mixture leaving the cyclone to be processed in the tank to flow into the tank by gravity via the mixture inlet.
31. Use according to item 30, wherein 90% by weight or more, such as 95% by weight or more of the sand in the mixture has a grain size of between 100 micron to 300 microns.
32. A method of operating the plant according to any of items 1 to 17, including the steps of:
measuring:
   a value of the dry matter of the raw stream of sand mixed with manure liquid, and/or
   flow as measured by a flow meter for registering a second flow of material from the cyclone, and/or
   flow as measured by a flow meter of the raw stream of sand mixed with manure liquid into the cyclone;
sending an adjustment command from the control unit to the actuator based on the measurements;
the actuator adjusting the first clamping body to vary the cross-section of the through-going passage of the flow restriction portion thereby adjusting the output flow of the mixture into the tank.

### REFERENCES

100 sand-manure liquid separation plant
1 tank for “raw manure”
2 dry matter meter
3 pump
4 pipe
5 macerator
6 cyclone
7 tank for processing a mixture of sand and manure liquid
9 flow meter
13 outlet of the tank
14 outlet for sludge
15 screw conveyor
16 water arrangement including water inlets
17 water valve
22 discharged sand
23 rotary screen filter
24 flush water tank
25 tank
200 flow restriction portion
26 outlet portion of the cyclone
28 through-going passage
29 clamping body
30 actuator
42 first segment(s)
44 thin walled second segment(s)
50 top portion
52 mixture inlet
56 fluid outlet(s)
58 overflow
40 stirrer
60 bottom portion
62 sand discharge
300 surface
500 bowl-shaped body

1. A sand-manure liquid separation plant comprising:
a tank for processing a mixture of sand and manure liquid; the tank comprising:
a top portion comprising a mixture inlet for introducing the mixture to be processed into the tank; and
a bottom portion comprising a sand discharge;
a pre-separator for a raw stream of sand mixed with manure liquid, the pre-separator comprising a cyclone, an outlet portion of the cyclone at a bottom part of the cyclone being arranged at the top portion of the tank for the mixture of sand and manure liquid leaving the cyclone to be processed in the tank to allow a flow of material into the tank by gravity via the mixture inlet, wherein the outlet portion of the cyclone comprises a flow restriction portion being of a resilient material, wherein the flow restriction portion has a through-going passage for the mixture of sand and manure liquid and an outer annular recess;
a control unit to control an output flow from the cyclone of the mixture of sand and manure liquid to be introduced into the tank via the through-going passage; and
a clamping body received by the outer annular recess and engaging an outer periphery of the flow restriction portion, the clamping body being adjustable to vary a cross-section of the through-going passage of the flow restriction portion.

2. The plant according to claim 1, wherein 90% by weight or more of the sand in the mixture of sand and manure liquid has a grain size of between 100 microns and 300 microns.

3. The plant according to claim 1, wherein adjustment of the clamping body follows an adjustment command sent by the control unit to an actuator, thereby adjusting the output flow of the mixture into the tank.

4. The plant according to claim 1, the through-going passage having a circular cross-section adjustable by the clamping body to assume a diameter in a range of 25 to 55 mm.

5. The plant according to claim 3, wherein the adjustment command is based on a measured value of dry matter in the raw stream of sand mixed with manure liquid.

6. The plant according to claim 3, wherein the adjustment command is based on flow measured by a flow meter of a second flow of material from the cyclone.

7. The plant according to claim 1, wherein at least the flow restriction portion of the outlet portion is manufactured from a polyurethane material having a shore hardness value (shore A) in a range of 30 to 90.

8. The plant according to claim 1, comprising a second clamping body having an adjustable cross-section and engaging an outer periphery of the clamping body.

9. The plant according to claim 1, the clamping body being configured to provide a uniform, or substantially uniform, radial pressure against the outer periphery of the flow restriction portion, the clamping body being a substantially ring-shaped clamping body or a segmented clamping body.

10. The plant according to claim 1, the clamping body being removable from the outlet portion.

11. A cyclone comprising:
a bottom part comprising an outlet portion that comprises a flow restriction portion being of a resilient material and a through-going passage, the flow restriction portion comprising an outer annular recess; and
a clamping body received by the outer annular recess and engaging an outer periphery of the flow restriction portion, the clamping body being adjustable to vary a cross-section of the through-going passage of the flow restriction portion.

12. The cyclone according to claim 11, wherein adjustment of the clamping body follows an adjustment command sent by a control unit to an actuator, thereby adjusting an output flow from the cyclone.

13. The cyclone according to claim 11, the through-going passage having a circular cross-section that is adjustable by the clamping body to assume a diameter in a range of 25 to 55 mm.

14. The cyclone according to claim 11, wherein the flow restriction portion of the outlet portion is manufactured from a polyurethane material and having a shore hardness value (shore A) in a range of 30 to 90.

15. The cyclone according to claim 11, further comprising a second clamping body having an adjustable cross-section and engaging an outer periphery of the clamping body.

16. The cyclone according to claim 11, the clamping body being configured to provide a uniform, or substantially uniform, radial pressure against the outer periphery of the flow restriction portion, the clamping body being a substantially ring-shaped clamping body or a segmented clamping body.

17. The cyclone according to claim 11, the clamping body being removable from the tubular outlet portion.

18. The cyclone according to claim 11, for processing a mixture of sand and manure liquid, wherein 90% by weight or more of the sand in the mixture has a grain size of between 100 microns and 300 microns.

19. A sand-manure liquid separation plant comprising:
a tank for processing a mixture of sand and manure liquid; the tank comprising:
a top portion comprising a mixture inlet for introducing the mixture of sand and manure liquid to be processed into the tank; and
a bottom portion comprising a sand discharge;
a pre-separator for a raw stream of sand mixed with manure liquid, the pre-separator comprising a cyclone, an outlet portion of the cyclone at a bottom part of the cyclone being arranged at the top portion of the tank for the mixture of sand and manure liquid leaving the cyclone to be processed in the tank to allow a flow of material into the tank by gravity via the mixture inlet;
wherein the outlet portion of the cyclone comprising a flow restriction portion being of a resilient material and a through-going passage for the mixture of sand and manure liquid,
a control unit to control an output flow from the cyclone of the mixture of sand and manure liquid to be introduced into the tank via the through-going passage;
a clamping body engaging an outer periphery of the flow restriction portion, the clamping body being adjustable to vary the cross-section of the through-going passage of the flow restriction portion; and
wherein the flow restriction portion of the outlet portion is manufactured from a polyurethane material having a shore hardness value (shore A) in a range of 30 to 90.

20. The plant according to claim 19, wherein the through-going passage has a circular cross-section that is adjustable by the clamping body to assume a diameter in a range of 25 to 55 mm.

21. The plant according to claim 19, wherein 90% by weight or more of the sand in the mixture has a grain size of between 100 microns and 300 microns.

22. The plant according to claim 19, wherein adjustment of the clamping body follows an adjustment command sent by the control unit to an actuator, thereby adjusting the output flow of the mixture of sand and manure liquid into the tank.

23. The plant according to claim 22, wherein the adjustment command is based on a measured value of dry matter in the raw stream of sand mixed with manure liquid.

24. The plant according to claim 22, wherein the adjustment command is based on flow measured by a flow meter of a second flow of material from the cyclone.

25. The plant according to claim 19, further comprising a second clamping body having an adjustable cross-section and engaging an outer periphery of the clamping body.

26. The plant according to claim 19, the clamping body being configured to provide a uniform, or substantially uniform, radial pressure against the outer periphery of the flow restriction portion, the clamping body being a substantially ring-shaped clamping body or a segmented clamping body.

27. A cyclone comprising:
a bottom part comprising an outlet portion that comprises a flow restriction portion of a resilient material and a through-going passage;
a clamping body engaging an outer periphery of the flow restriction portion, the clamping body being adjustable to vary a cross-section of the through-going passage of the flow restriction portion, wherein at least the flow restriction portion of the outlet portion is manufactured from a polyurethane material having a shore hardness value (shore A) in the range of 30 to 90.

28. The cyclone according to claim 27, the through-going passage having a circular cross-section that is adjustable by the clamping body to assume a diameter in a range of 25 to 55 mm, the clamping body being removable from the outlet portion and replaceable.

29. The cyclone according to claim 27, wherein the adjustment of the clamping body follows an adjustment command sent by a control unit to an actuator, thereby adjusting an output flow of the mixture into the tank.

30. The cyclone according to claim 27, further comprising a second clamping body having an adjustable cross-section and engaging an outer periphery of the clamping body.

31. The cyclone according to claim 27, the clamping body being configured to provide a uniform, or substantially uniform, radial pressure against the outer periphery of the flow restriction portion, the clamping body being a substantially ring-shaped clamping body or a segmented clamping body.

32. The cyclone according to claim 27, the flow restriction portion comprising including an outer annular recess, the clamping body received within the outer annular recess.

33. The cyclone according to claim 27, for processing a mixture of sand and manure liquid, wherein 90% by weight or more of the sand in the mixture has a grain size of between 100 microns and 300 microns.

34. A method of operating a plant comprising:
a tank for processing a mixture of sand and manure liquid; the tank comprising:
a top portion comprising a mixture inlet for introducing the mixture to be processed into the tank; and
a bottom portion comprising a sand discharge;
a pre-separator for a raw stream of sand mixed with manure liquid, the pre-separator comprising a cyclone, an outlet portion of the cyclone at a bottom part of the cyclone being arranged at the top portion of the tank for the mixture of sand and manure liquid leaving the cyclone to be processed in the tank to allow a flow of material into the tank by gravity via the mixture inlet, wherein the outlet portion of the cyclone comprises a flow restriction portion being of a resilient material, wherein the flow restriction portion has a through-going passage for the mixture of sand and manure liquid and an outer annular recess;
a control unit to control an output flow from the cyclone of the mixture of sand and manure liquid to be introduced into the tank via the through-going passage; and
a clamping body received by the outer annular recess and engaging an outer periphery of the flow restriction portion, the clamping body being adjustable to vary a cross-section of the through-going passage of the flow restriction portion;
the method comprising:
measuring at least one of the following:
a value of dry matter of the raw stream of sand mixed with manure liquid;
flow as measured by a flow meter for registering a flow of material from the cyclone; and
flow as measured by a flow meter of the raw stream of sand mixed with manure liquid into the cyclone;
sending an adjustment command from the control unit to the actuator based on the measuring;
the actuator adjusting the clamping body to vary the cross-section of the through-going passage of the flow restriction portion thereby adjusting the output flow of the mixture into the tank.

35. A method of operating a plant comprising:
a tank for processing a mixture of sand and manure liquid; the tank comprising:
a top portion comprising a mixture inlet for introducing the mixture of sand and manure liquid to be processed into the tank; and
a bottom portion comprising a sand discharge;
a pre-separator for a raw stream of sand mixed with manure liquid, the pre-separator comprising a cyclone, an outlet portion of the cyclone at a bottom part of the cyclone being arranged at the top portion of the tank for the mixture of sand and manure liquid leaving the cyclone to be processed in the tank to allow a flow of material into the tank by gravity via the mixture inlet;
wherein the outlet portion of the cyclone comprising a flow restriction portion being of a resilient material and a through-going passage for the mixture of sand and manure liquid;
a control unit to control an output flow from the cyclone of the mixture of sand and manure liquid to be introduced into the tank via the through-going passage;
a clamping body engaging an outer periphery of the flow restriction portion, the clamping body being adjustable to vary the cross-section of the through-going passage of the flow restriction portion; and
wherein the flow restriction portion of the outlet portion is manufactured from a polyurethane material having a shore hardness value (shore A) in a range of 30 to 90;
the method comprising:
measuring at least one of the following:
a value of dry matter of the raw stream of sand mixed with manure liquid;
flow as measured by a flow meter for registering a flow of material from the cyclone; and
flow as measured by a flow meter of the raw stream of sand mixed with manure liquid into the cyclone;
sending an adjustment command from the control unit to the actuator based on the measuring;
the actuator adjusting the clamping body to vary the cross-section of the through-going passage of the flow restriction portion thereby adjusting the output flow of the mixture into the tank.
